(19) United States
(12) Patent Application Publication
(10) Pub. No.: US 2015/0280576 A1
(43) Pub. Date: Oct. 1, 2015

(54) System and Method for a Switched Mode Power Supply

(71) Applicant: Infineon Technologies Austria AG, Villach (AT)

(72) Inventors: Torsten Hinz, Augsburg (DE); Martin Krueger, Oberschleissheim (DE); Markus Schnell, Muenchen (DE)

(21) Appl. No.: 14/615,720

(22) Filed: Feb. 6, 2015

Related U.S. Application Data
(60) Provisional application No. 61/970,789, filed on Mar. 26, 2014.

(51) Int. Cl. H02M 3/335

(52) U.S. Cl. CPC H02M 3/33507

(57) ABSTRACT

In accordance with an embodiment, a method of controlling a switched-mode power supply includes demagnetizing a secondary winding of a transformer, monitoring an ending condition of the demagnetizing, tracking an elapsed time until the ending condition is detected based on the monitoring, and shutting down the switched-mode power supply when the elapsed time exceeds a predetermined threshold.

This application claims the benefit of U.S. Provisional Application No. 61/970,789, filed on Mar. 26, 2014, which application is hereby incorporated herein by reference in its entirety.

### TECHNICAL FIELD

The present disclosure relates generally to an electronic device, and more particularly to a system and method for a switched mode power supply.

### BACKGROUND

Power supply systems are pervasive in many electronic applications from computers to automobiles. Generally, voltages within a power supply system are produced by performing a DC/DC, a DC/AC, and/or an AC/DC conversion by operating a switch loaded with an inductor or transformer. DC-DC converters, such as buck converters, are used in systems that use multiple power supplies. For example, in an automotive system, a microcontroller that nominally operates at a 5V power supply voltage may use a switched-mode power supply, such as a buck converter to produce a local 5V power supply from the 12V car battery. Such a power supply may be operated by driving an inductor using a high-side switching transistor coupled to a DC power supply. Under moderate to heavy load conditions, the output voltage of the power supply is controlled by varying the pulse-width of the time during which the switching transistor is in a conductive state.

A SMPS usually includes at least one switch and an inductor or transformer. Some specific topologies include buck converters, boost converters, and flyback converters, among others. A control circuit is commonly used to open and close the switch to charge and discharge the inductor. In some applications, the current supplied to the load and/or the voltage supplied to the load is controlled via a feedback loop.

A number of different parameters are often specified in the design of SMPS. One such parameter is efficiency, which is defined as the power output by the power converter divided by the power input to the power converter.

### SUMMARY

In accordance with an embodiment, a method of controlling a switched-mode power supply includes demagnetizing a secondary winding of a transformer, monitoring an ending condition of the demagnetizing, tracking an elapsed time until the ending condition is detected based on the monitoring, and shutting down the switched-mode power supply when the elapsed time exceeds a predetermined threshold.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a-b illustrate an embodiment flyback converter and a corresponding waveform diagram;

FIG. 2 illustrates a waveform diagram illustrating the effect of a short circuit condition on a switched-mode power supply;

FIG. 3 illustrates a block diagram of an embodiment power supply controller integrated circuit; and

FIG. 4 illustrates a block diagram of an embodiment method.

Corresponding numerals and symbols in different figures generally refer to corresponding parts unless otherwise indicated. The figures are drawn to clearly illustrate the relevant aspects of the preferred embodiments and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, a switched-mode power supply system using a flyback topology. Embodiments of the present invention may also be applied to other switched-mode power supply topologies, as well as non-switched mode power supplies, feedback control systems, and other types of electronic circuits.

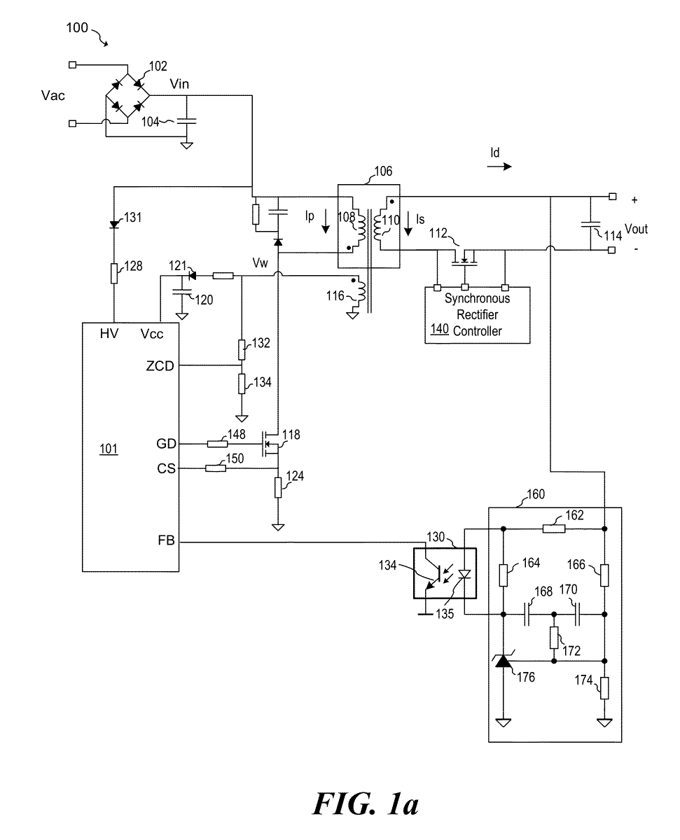

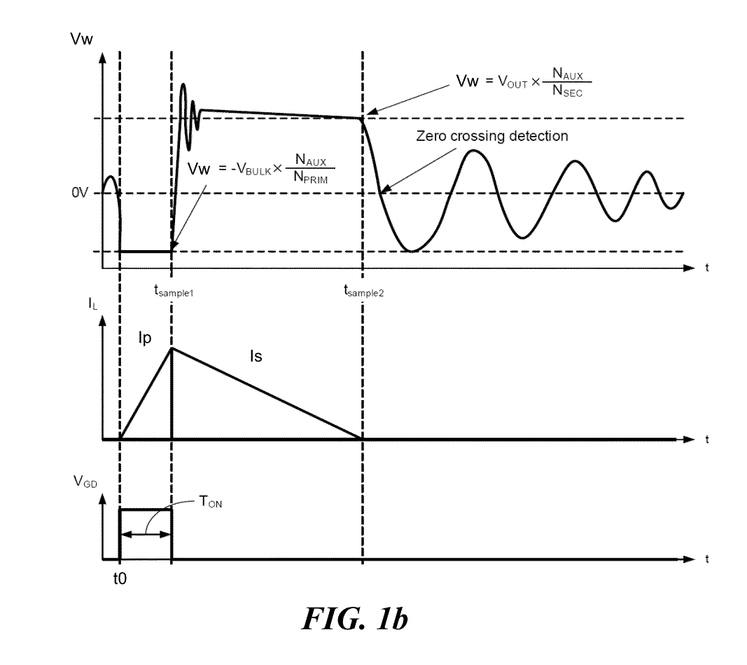

FIG. 1a illustrates switched-mode power supply system 100 according to an embodiment of the present invention. As shown, switched-mode power supply system 100 is configured as a flyback converter. During operation, an AC voltage at port VAC is rectified and filtered into a DC voltage using input rectifier 102 and input filter capacitor 104. In some embodiments, input rectifier 102 may be implemented with a diode, with a diode bridge, or other rectification device. The resulting DC voltage is applied to primary winding 108 of transformer 106. Primary side controller 101 activates and deactivates switching transistor 118 via pin GD and series resistor 148 such that energy from the primary side of transformer 106 is transferred to the secondary side of transformer 106. Synchronous rectifier driver controller 140 in concert with switching transistor 112 and capacitor 114 rectifies and filters the output of the secondary side of transformer 106. While the secondary current Is is depicted as being rectified using synchronous rectification techniques, a diode may be used in place of rectifier driver controller 140 and switching transistor 112 in some embodiments.

The output voltage of the power supply taken at node Vout is conditioned by feedback compensation network 160 and transferred to input pin FB of primary side controller 101 via optocoupler 130. As shown optocoupler 130 is implemented using light emitting diode 135 and phototransistor 134. It should be understood that in alternative embodiments, other galvanically isolating structures could be used such as coreless transformers. As shown, feedback compensation network 160 includes resistors 162, 164, 166, 172 and 174; capacitors 168 and 170; and programmable reference 176. The values of feedback compensation network 160 may be selected to stabilize the voltage feedback loop of the power supply. It should be understood that feedback compensation network 160 is just one example of various embodiment feedback networks that may be implemented in embodiment switched-mode power supplies. In addition output voltage feedback, the current through the primary winding is fed back via resistors 124 and 150 and pin CS.

Referring to FIG. 1b, the primary winding current Ip increases when node GD activates switching transistor 118, for example, between time t₀ and time tₛₐₘₚₗₑ₁. The slope of the increase of the primary current IP when switching transistor 118 is activated is substantially proportional to the voltage level of the input voltage Vin and substantially inversely proportional to the inductance L of the primary winding 108 and the transformer, respectively. That is:

dIin/dt=Vin/L.

When switching transistor 118 is activated, a voltage across primary winding 108 substantially corresponds to voltage Vin and a voltage across secondary winding 110 substantially corresponds to −N22/N21·Vin, where N21 represents the number of windings of primary winding 108 and N22 represents the number of windings of secondary winding 110. As the voltage across the secondary winding 110 is negative during the on-period (which is by virtue of the primary winding 108 and the secondary winding 110 having opposite winding senses) current Is through the secondary winding 110 is zero when switching transistor 118 is activated.

When switching transistor 118 is deactivated, for example, at time ₜₛₐₘₚₗₑ₁, the voltage across the primary winding 108 and, consequently, the voltage across the secondary winding 110 reverses polarity and increases until the voltage across the secondary winding 110 substantially corresponds to the output voltage Vout plus a voltage that corresponds to the voltage across secondary side switching transistor 112 (or to a forward diode voltage in non-synchronous rectifier embodiments).

By virtue of the inductive coupling between the auxiliary winding 116 and the primary winding 108, the voltage level of the auxiliary voltage Vw during the time that switching transistor 118 is active (i.e., when driving voltage GD is high) substantially corresponds to

Vw=−N23/N21·Vin,

where N23 represents the number of windings of the auxiliary winding 116. When switching transistor 118 is inactive, (i.e., when node GD is low), the voltage level of the auxiliary voltage Vaux substantially corresponds to

Vw=N23/N22·Vout

as long as the current Is through the secondary winding 110 has not decreased to zero. As the secondary side current Is decreases to zero, that is, as the transformer is completely demagnetized, the secondary side voltage and, consequently, the auxiliary voltage Vw becomes zero. Parasitic effects such as, for example, parasitic capacitances of the transformer may cause ringing or oscillations of the auxiliary voltage Vw, at the time when transformer 106 has become demagnetized, as shown in the plot of Vw starting at time tₛₐₘₚₗₑ₂. This ringing occurs because switching transistor 112 on the secondary side of transformer 106 is turned off and presents an open circuit to secondary winding 110. As such, the impedance at the drain of switching transistor 118 appears as a parallel resonance that includes the inductance of primary winding 108 in parallel with the capacitance coupled to the drain of the switching transistor.

Controller 101 may use this ringing phenomenon to determine when the secondary side winding 110 is completely demagnetized, as well as when to turn on the primary side switch on again in the next cycle. For example, in some embodiments, the zero crossings of auxiliary winding voltage Vw is used to determine the time at which secondary side winding 110 is completely demagnetized. Moreover, in some embodiments that implement a quasi-resonant mode of operation, valley switching may be implemented in which the primary side switch is turned on when auxiliary winding voltage Vw is a minimum voltage. This is often referred to as “valley switching.” Moreover, when primary side switching transistor 118 turns on after secondary winding 110 has been demagnetized, the power supply is said to operate in a discontinuous conduction mode (DCM). When primary side switching transistor 118 turns on before secondary winding 110 has been demagnetized, the power supply is said to operate in a continuous conduction mode (CCM).

In some embodiments, auxiliary winding 116 provides power to primary side controller 101 via rectifying diode 120, capacitor 121 and pin Vcc when the power supply is in operation. When the power supply is starting up, however, power may be provided from the primary supply Vin to high voltage pin HV via diode 131 and resistor 128.

In some embodiments, controller 101 prevents the power supply from operating in CCM mode in order to avoid shoot through current in the secondary side. One way in which CCM is prevented is by shutting down the power supply if an ending condition of the demagnetization of secondary winding 110 is not detected. For example, if zero crossing detector coupled to pin ZCD does not detect a zero crossing within a specified period of time, for example, between about 50 μs and about 2 s. Alternatively time periods outside of this range may be used depending on the particular embodiment and its specifications. Such a condition may occur, for example, under low impedance load or short circuit conditions in which current circulating in the secondary winding and the load of the power supply are very slow to decay.

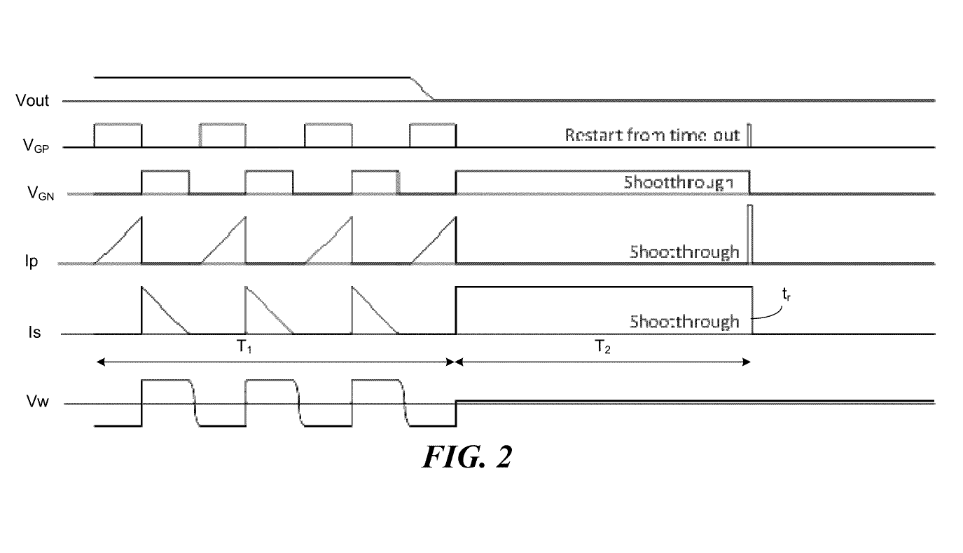

FIG. 2 illustrates a waveform diagram that contrasts the operation of a flyback power supply operating under normally loaded conditions during time period T₁, and under short circuit or very low impedance load impedance conditions during time period T₂. FIG. 2 shows power supply output voltage Vout, the gate voltage V_{GP} of primary-side switching transistor 118, the gate voltage V_{GS} of secondary-side switching transistor 112, primary side current Ip, Secondary side current Is and auxiliary winding voltage Vw. As shown, during normally loaded conditions, the gate voltage V_{GP} of primary-side switching transistor 118, and the gate voltage V_{GS} of secondary-side switching transistor 112 are driven alternatively corresponding to increasing primary current Ip when primary-side switching transistor 118 and decreasing secondary side current Is when secondary-side switching transistor 112 is active. During time period T₂, however, the output of the power supply is short circuited causing a corresponding decrease in output voltage Vout. Because of the low impedance loading, secondary side current Is has a very slow decay when secondary-side switching transistor 112 remains active. If the switching of the primary-side switching transistor 118 is resumed at time tᵣ, if the short circuit still exits shoot through current results in the primary winding 108.

In an embodiment, the effect of such shoot through current on efficiency may be reduced by stopping the switching of primary-side switching transistor 118 after a specified timeout period if an ending condition, such as a zero crossing on auxiliary winding voltage Vw is not detected. After this timeout period, the switched-mode power supply may be placed in a low power or sleep mode. After a period of time, for example, between one seconds and three second, the power supply is turned back on again and switching is resumed. If the short circuit is again determined, for example, due to lack of detected zero crossing of the auxiliary winding voltage, the power supply is once again shut down for the predetermined period of time. In some embodiments, the power supply is permanently shut off after a predetermined number of attempts. For example, if after ten attempts, the power supply is unable to successfully start-up and detects a zero crossing of the auxiliary winding voltage, the power supply is shut down without any further startup attempts. It should be understood that in alternative embodiments, greater or fewer startup attempts may be made depending on the particular application and its specifications.

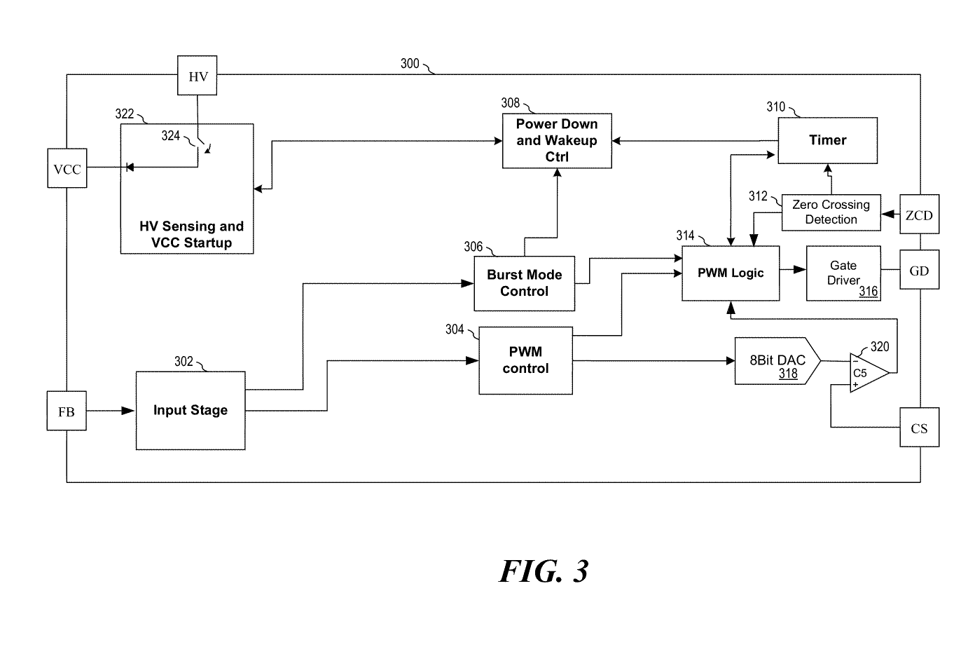

FIG. 3 illustrates a block diagram of an embodiment power supply controller integrated circuit 300. In an embodiment, input stage 302 processes feedback signal from pin FB and provides feedback to PWM control block 304 or burst mode control block 306 depending on the particular mode of operation. PWM control block 304 and burst mode control block 306 may implement PWM and burst mode control methods known in the art. Current feedback of primary side current is provided by comparing a voltage a node CS with a reference voltage generated by digital-to-analog converter (DAC) 318 using comparator 320. PWM control block 304 may provide a ramping input to DAC 318 to provide slope compensation using circuits and methods known in the art. In some embodiments, PWM control block 304 may directly provide an analog voltage to comparator 616.

PWM logic block 314 may include, for example, a pulse generator and with a duty cycle controllable by PWM control block 304. Gate driver 316 provides a drive signal for a primary-side switching transistor. In some embodiments, gate driver 316 may be located off chip.

In an embodiment, zero crossing detection circuit 312 coupled to pin ZCD monitors a voltage of an auxiliary winding of a transformer. Zero crossing detection circuit 312 may provide zero crossing and valley detection to enable power supply controller integrated circuit 300 to operate in a quasi-resonant mode of operation. During operation, PWM logic 314, which generates a switching pattern for a primary-side switching signal at pin GD, activates timer 310. This activation may occur, for example, when the switch driving signal at pin GD is de-asserted, or at some other time. Next, when zero crossing detection circuit 312 detects an ending condition of the demagnetization of the secondary side winding, for example, a zero crossing of the auxiliary winding voltage and/or when the auxiliary winding voltage crosses a predetermined threshold, timer 310 is again notified. However, if zero crossing detection circuit 312 does not notify timer 310 within a predetermined period of time, PWM logic 413 is deactivated and/or a request is made to power down and wakeup controller 308 to shut down power supply controller integrated circuit 300 or place power supply controller integrated circuit 300 in a low power mode, such as a sleep mode. In such a sleep mode, most of the circuitry within power supply controller integrated circuit 300 may be shut off or reduced in order to save power. After a predetermined period of time, power down and wakeup controller 308 powers up power supply controller integrated circuit 300 and again attempts to operate the power supply. In some embodiments, this period of time may be between, for example, 1 second and three seconds, however, times outside of this range may also be used.

In some embodiments, power to power supply controller integrated circuit 300 is supplied by the auxiliary winding via pin VCC. If the auxiliary winding has been discharged, power to integrated circuit 300 may be taken from the primary side transformer power supply via high voltage pin HV. Once switching operation is reestablished, power to integrated circuit 300 may be once again provided via pin VCC. Power may be switched between the two supply pins via switch 324 under the control of HV sensing and Vcc startup circuit 322.

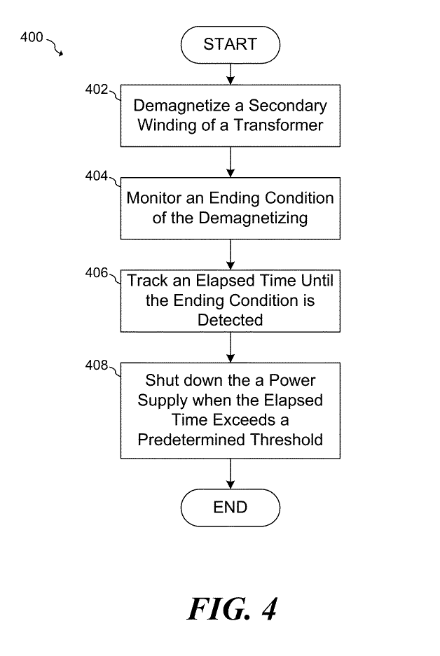

FIG. 4 illustrates a block diagram of method 400 of operating a switched mode power supply. In step 402, a secondary winding of a power supply is demagnetized. In some embodiments, this demagnetization may be effected by switching off a primary-side switching transistor coupled to a primary-side winding of a transformer and turning on a secondary-side switching transistor couple to a secondary winding of the transformer. Next, an ending condition of the demagnetization is monitored in step 404. This ending condition may include, for example, a threshold crossing of a voltage of an auxiliary winding of the transformer, or a predetermined number of threshold crossings. In step 406, an elapsed time until the ending condition is determined. In some embodiments, this elapsed time may start from the time that the primary-side switching transistor is turned off after the primary-side winding is magnetized. In other embodiments, the elapsed time is started at some other time, including, but not limited to the time at which the primary-side switching transistor is turned on at the beginning of a cycle. If the elapsed time exceeds a predetermined threshold, the power supply is shut down in step 408. Shutting down may include, for example turning off the primary-side and/or the secondary-side switching transistors and disabling periodic switching of the power supply. In some embodiments, the power supply and/or a power supply controller may be placed in a low power mode or a sleep mode. In some embodiments, the power supply is restarted after a predetermined period of time of at least one second. Alternatively, this predetermined period of time may be less than one second.

In accordance with various embodiments, circuits or systems may be configured to perform particular operations or actions by virtue of having hardware, software, firmware, or a combination of them installed on the system that in operation causes or cause the system to perform the actions. One general aspect includes a method of controlling a switched-mode power supply including: demagnetizing a secondary winding of a transformer, monitoring an ending condition of the demagnetizing, tracking an elapsed time until the ending condition is detected based on the monitoring, and shutting down the switched-mode power supply when the elapsed time exceeds a predetermined threshold. Other embodiments of this aspect include corresponding circuits and systems configured to perform the various actions of the methods.

Implementations may include one or more of the following features. The method where monitoring includes monitoring a voltage of a secondary winding of the switched-mode power supply. The method where monitoring includes monitoring a voltage of an auxiliary winding of the switched-mode power supply. The method where monitoring for the ending condition of the demagnetizing includes monitoring when the voltage of an auxiliary winding crosses a predetermined threshold. The method where monitoring for the ending condition further includes monitoring when the voltage of an auxiliary winding crosses the predetermined threshold for the nth time. The method where the ending condition includes a zero crossing of the voltage of the auxiliary winding. The method where detecting the zero crossing in the voltage of the auxiliary winding including determining an nth zero crossing. The method where tracking the elapsed time includes using a counter. The method where the predetermined threshold where the predetermined threshold is between about 50 μs and about 2 s. The method further including restarting the switched mode power supply after shutting down the switched-mode power supply. The method where restarting the switched mode power supply includes restarting the switched mode power supply at least 1 second after shutting down the switched-mode power supply. The method where shutting down the switched-mode power supply includes shutting off a primary switch coupled to a primary winding of the transformer. The method further including energizing a primary winding of the transformer including turning on a semiconductor switch coupled to the primary winding of the transformer. The method where shutting down the switched-mode power supply includes shutting down a semiconductor switch coupled to a primary winding of the transformer and stopping a periodic drive of the semiconductor switch. The method where the predetermined threshold is set to prevent continuous conduction mode (ccm) operation. Implementations of the described techniques may include hardware, a method or process, or computer software on a computer-accessible medium.

One general aspect includes a power supply controller including: a switch controller circuit having an output terminal configured to be coupled to a control node of a switching transistor coupled to a primary winding of a transformer, the switch controller configured to cause the switching transistor to energize the primary winding of the transformer; transformer interface circuit configured to be coupled to a transformer, and to monitor for an ending condition of a demagnetization of a secondary winding of the transformer; and a timer circuit configured to determine an elapsed time until the ending condition is detected by the transformer interface circuit and to shut down the switch controller circuit when the elapsed time exceeds a predetermined threshold. Other embodiments of this aspect include corresponding circuits and systems configured to perform the various actions of the methods.

Implementations may include one or more of the following features. The power supply controller where the transformer interface circuit is configured to be coupled to an auxiliary winding of the transformer. The power supply controller where the ending condition includes a voltage of the auxiliary winding crossing a predetermined threshold. The power supply controller where the predetermined threshold is about 0 v. The power supply controller where ending condition includes a voltage of the auxiliary winding crossing a predetermined threshold nth times. The power supply controller where the timer includes a counter. The power supply controller where the predetermined threshold is between about 50 μs and about 2 s. The power supply controller further including a power management circuit configured to start up the switch controller after it is shut down by the timer circuit. The power supply controller where the power management circuit is configured to start up the switch controller at least 1 second after the switch controller is shut down. The power supply controller where the switch controller circuit, the transformer interface circuit and the timer circuit are disposed on an integrated circuit. The power supply controller where the predetermined threshold is set to prevent continuous conduction mode (ccm) operation. Implementations of the described techniques may include hardware, a method or process, or computer software on a computer-accessible medium.

One general aspect includes a switched-mode power supply including: a transformer; a switching transistor coupled to a primary winding of the transformer; a switch controller circuit having an output terminal coupled to a control node of a switching transistor; a transformer interface circuit coupled to a transformer, and configured to monitor for an ending condition of a demagnetization of a secondary winding of the transformer; and a timer circuit configured to determine an elapsed time until the ending condition is detected by the transformer interface circuit and to shut down the switch controller circuit when the elapsed time exceeds a predetermined threshold. Other embodiments of this aspect include corresponding circuits and systems configured to perform the various actions of the methods.

Implementations may include one or more of the following features. The switched mode power supply further including a gate driver circuit coupled to the output terminal of the switch controller circuit. Implementations of the described techniques may include hardware, a method or process, or computer software on a computer-accessible medium.

Advantages of some embodiments include the ability to prevent continuous conduction mode in switched-mode power supply converters that are loaded with a very low impedance and/or have a shorted output. A further advantage of some embodiments includes the ability to save power when an output of a power supply is short-circuited.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media that is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. In addition, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and micro-wave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules con-figured for encoding and decoding, or incorporated in a combined codec. In addition, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description.

What is claimed is:

1. A method of controlling a switched-mode power supply comprising:
demagnetizing a secondary winding of a transformer;
monitoring an ending condition of the demagnetizing;
tracking an elapsed time until the ending condition is detected based on the monitoring; and
shutting down the switched-mode power supply when the elapsed time exceeds a predetermined threshold.

2. The method of claim 1, wherein monitoring comprises monitoring a voltage of a secondary winding of the switched-mode power supply.

3. The method of claim 1, wherein monitoring comprises monitoring a voltage of an auxiliary winding of the switched-mode power supply.

4. The method of claim 3, wherein monitoring for the ending condition of the demagnetizing comprises monitoring when the voltage of an auxiliary winding crosses a predetermined threshold.

5. The method of claim 4, wherein monitoring for the ending condition further comprises monitoring when the voltage of an auxiliary winding crosses the predetermined threshold for the n^{th} time.

6. The method of claim 3, wherein the ending condition comprises a zero crossing of the voltage of the auxiliary winding.

7. The method of claim 6, wherein detecting the zero crossing in the voltage of the auxiliary winding comprising determining an n^{th} zero crossing.

8. The method of claim 1, wherein tracking the elapsed time comprises using a counter.

9. The method of claim 1, wherein the predetermined threshold wherein the predetermined threshold is between about 50 μs and about 2 s.

10. The method of claim 1, further comprising restarting the switched mode power supply after shutting down the switched-mode power supply.

11. The method of claim 10, wherein restarting the switched mode power supply comprises restarting the switched mode power supply at least 1 second after shutting down the switched-mode power supply.

12. The method of claim 1, wherein shutting down the switched-mode power supply comprises shutting off a primary switch coupled to a primary winding of the transformer.

13. The method of claim 1, further comprising energizing a primary winding of the transformer comprising turning on a semiconductor switch coupled to the primary winding of the transformer.

14. The method of claim 1, wherein shutting down the switched-mode power supply comprises shutting down a semiconductor switch coupled to a primary winding of the transformer and stopping a periodic drive of the semiconductor switch.

15. The method of claim 1, wherein the predetermined threshold is set to prevent continuous conduction mode (CCM) operation.

16. A power supply controller comprising:
a switch controller circuit having an output terminal configured to be coupled to a control node of a switching transistor coupled to a primary winding of a transformer, the switch controller configured to cause the switching transistor to energize the primary winding of the transformer;
transformer interface circuit configured to be coupled to a transformer, and to monitor for an ending condition of a demagnetization of a secondary winding of the transformer; and
a timer circuit configured to determine an elapsed time until the ending condition is detected by the transformer interface circuit and to shut down the switch controller circuit when the elapsed time exceeds a predetermined threshold.

17. The power supply controller of claim 16, wherein the transformer interface circuit is configured to be coupled to an auxiliary winding of the transformer.

18. The power supply controller of claim 17, wherein the ending condition comprises a voltage of the auxiliary winding crossing a predetermined threshold.

19. The power supply controller of claim 18, wherein the predetermined threshold is about 0 V.

20. The power supply controller of claim 18, wherein ending condition comprises a voltage of the auxiliary winding crossing a predetermined threshold n^{th} times.

21. The power supply controller of claim 16, wherein the timer comprises a counter.

22. The power supply controller of claim 16, wherein the predetermined threshold is between about 50 μs and about 2 s.

23. The power supply controller of claim 16, further comprising a power management circuit configured to start up the switch controller after it is shut down by the timer circuit.

24. The power supply controller of claim 23, wherein the power management circuit is configured to start up the switch controller at least 1 second after the switch controller is shut down.

25. The power supply controller of claim 16, wherein the switch controller circuit, the transformer interface circuit and the timer circuit are disposed on an integrated circuit.

26. The power supply controller of claim 16, wherein the predetermined threshold is set to prevent continuous conduction mode (CCM) operation.

27. A switched-mode power supply comprising:
a transformer;
a switching transistor coupled to a primary winding of the transformer;
a switch controller circuit having an output terminal coupled to a control node of a switching transistor;
a transformer interface circuit coupled to a transformer, and configured to monitor for an ending condition of a demagnetization of a secondary winding of the transformer; and
a timer circuit configured to determine an elapsed time until the ending condition is detected by the transformer interface circuit and to shut down the switch controller circuit when the elapsed time exceeds a predetermined threshold.

28. The switched mode power supply of claim 27, further comprising a gate driver circuit coupled to the output terminal of the switch controller circuit.
